(19) United States
(12) Patent Application Publication
(10) Pub. No.: US 2010/0155607 A1
(43) Pub. Date: Jun. 24, 2010

(54) Radiographic image capturing system, processor and radiographic image capturing method

(75) Inventors: Masato Hattori, Minami-ashigara-shi (JP); Naoyuki Nishino, Minami-ashigara-shi (JP); Yutaka Yoshida, Tokyo (JP); Yasunori Ohta, Yokohama-shi (JP); Keiji Tsubota, Minami-ashigara-shi (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/654,480

(22) Filed: Dec. 22, 2009

(30) Foreign Application Priority Data
Dec. 24, 2008 (JP) 2008-328247
Nov. 30, 2009 (JP) 2009-271514

(51) Int. Cl. G06F 3/048; G01J 1/42; G01T 1/20

(52) U.S. Cl. 250/363.01; 250/393; 715/810

(57) ABSTRACT

A processor of an radiographic image capturing system comprises a display unit for displaying a registration menu through which ordering information for image-capturing is registered, the ordering information including an image capturing unit to be used and image capturing conditions, a detecting unit for detecting a type of the image capturing unit to be used, and a selecting unit for selecting the registration menu to be displayed on the display unit, depending on the detected type of the image capturing unit to be used.

### CROSS-REFERENCE TO RELATED APPLICATION

This application is based upon and claims the benefit of priority from Patent Applications No. 2008-328247 filed on Dec. 24, 2008 and No. 2009-271514 filed on Nov. 30, 2009, in the Japan Patent Office, of which the contents are incorporated herein by reference.

### BACKGROUND OF THE INVENTION

1. Field of the Invention

The present invention relates to a radiographic image capturing system and a radiographic image capturing method in which a registration menu is displayed on a display unit depending on an image capturing unit to be used, ordering information for image-capturing is registered, and a radiographic image is acquired according to image capturing conditions included in the registered ordering information.

The present invention also relates to a processor for supplying the image capturing conditions to the image capturing unit and processing the radiographic image that has been captured by the image capturing unit based on the image capturing conditions.

2. Description of the Related Art

In the medical field, there have widely been used image capturing apparatus which apply radiation to a subject and guide the radiation that has passed through the subject to a radiation conversion panel, which captures a radiographic image from the radiation.

One known radiation conversion panel is a stimulable phosphor panel which stores a radiation energy representative of a radiographic image in a phosphor. When the stimulable phosphor panel is irradiated with stimulating light, the phosphor emits stimulated light representative of the stored radiographic image. The stimulable phosphor panel with the radiographic image recorded therein is supplied to a reading apparatus which reads the stored radiographic image as a visible radiographic image.

In sites of medical practice such as operating rooms or the like, it is necessary to read recorded radiographic image information immediately from a radiation conversion panel for the purpose of quickly and appropriately treating the patient. As a radiation conversion panel which meets such a requirement, there has been developed a direct-conversion type radiation detector for converting radiation directly into an electric signal or an indirect-conversion type radiation converter for converting radiation into visible light with a scintillator and then converting the visible light into an electric signal with a solid-state imaging device to read a detected radiographic image.

The image capturing apparatus using such a radiation conversion panel is controlled according to ordering information for image-capturing which is set by a doctor and on the basis of image capturing conditions supplied from a processor, and then a radiographic image is captured. In this case, the radiographic image captured by the image capturing apparatus is sent from the image capturing apparatus to the processor, subjected to a desired image-processing by the processor, and then interpreted by the doctor for the purpose of diagnosis.

In some cases, capturing of a radiographic image can not be appropriately performed with the image capturing apparatus that has been specified by the doctor. For example, when a subject to be imaged is an infant or a young child, he/she may not keep still during the image-capturing, or he/she may not appropriately communicate the region to be imaged, to a radiological technician. When the subject (infant, young child, etc.) moves around, the appropriate radiographic image thereof can not be acquired. Also, when the region to be imaged is not determined, the appropriate range for the image-capturing can not be set with respect to the subject.

Generally-used stimulable phosphor panels have a narrower range for image-capturing than radiation converters. Thus, when the region to be imaged of a subject is not clearly determined, the region to be imaged may be out of the range for the image-capturing. Further, when a radiographic image is captured using the stimulable phosphor panel, the stimulable phosphor panel needs to be supplied to a reading device after completion of the image-capturing, for reading the image. Accordingly, it takes a long period of time to determine whether an appropriate image has been captured or not. It is virtually impossible to make an infant or a young child keep still with respect to the image capturing apparatus during the long period of time.

On the other hand, the radiation converter has a wider range for image-capturing than the stimulable phosphor panel, and a radiographic image can be confirmed immediately after the image-capturing. Thus, even if movement of the subject (infant, young child, etc.) produces an inappropriate radiographic image, another radiographic image can be recaptured swiftly. The radiation converter is thus suitable for image-capturing of particularly infants and young children.

However, the doctor that sets ordering information for image-capturing does not always grasp correctly the situation in a site for the image-capturing of such a subject.

In the related art, a plurality of pieces of ordering information are sent from a processor to a flat panel detector (FPD) serving a radiation converter, and the pieces of ordering information are set and registered into the FPD. Also, the image capturing order based on the registered ordering information and the contents of the ordering information are modifiable, and the modified ordering information is sent from the FPD to the processor (see Japanese Laid-Open Patent Publication 2006-116001).

According to the conventional technique disclosed in Japanese Laid-Open Patent Publication 2006-116001, the ordering information itself can be modified, but the registration menus for modifying the ordering information are not switched depending on the type of radiation conversion panel. Thus, the radiological technician can not deal easily with switching of the type of radiation conversion panel.

### SUMMARY OF THE INVENTION

It is an object of the present invention to provide a radiographic image capturing system, a processor and a radiographic image capturing method in which a registration menu through which ordering information for image-capturing is registered is switched depending on the type of a radiation conversion panel to be used for the image-capturing, thereby enabling a radiological technician to register the ordering information easily and efficiently.

According to the present invention, a radiographic image capturing system comprises image capturing units for capturing a radiographic image of a subject, and a processor for supplying image capturing conditions to the image capturing units and processing the radiographic image captured by the image capturing units. The processor comprises a display unit for displaying a registration menu through which ordering information for image-capturing is registered, the ordering information including one of the image capturing units to be used and the image capturing conditions, a detecting unit for detecting a type of the one of the image capturing units to be used, and a selecting unit for selecting the registration menu to be displayed on the display unit, depending on the detected type of the one of the image capturing units to be used.

Also, according to the present invention, a processor supplies image capturing conditions to image capturing units for capturing a radiographic image of a subject and processes the radiographic image that has been captured by the image capturing units according to the image capturing conditions. The processor comprises a display unit for displaying a registration menu through which ordering information for image-capturing is registered, the ordering information including one of the image capturing units to be used and the image capturing conditions, a detecting unit for detecting a type of the one of the image capturing units to be used, and a selecting unit for selecting the registration menu to be displayed on the display unit, depending on the detected type of the one of the image capturing units to be used.

Further, according to the present invention, a radiographic image capturing method comprises the steps of displaying, on a display unit, a registration menu through which ordering information for image-capturing is registered, the ordering information including an image capturing unit to be used and image capturing conditions, detecting a type of the image capturing unit to be used, with a detecting unit, selecting the registration menu to be displayed on the display unit with a selecting unit, depending on the detected type of the image capturing unit to be used, supplying the image capturing conditions to the image capturing unit according to the selected registration menu, capturing a radiographic image with the image capturing unit based on the image capturing conditions, and processing the captured radiographic image with a processor.

With the above arrangement, since the type of the radiation conversion panel to be used for image-capturing is detected and the registration menu depending on the type is displayed on the display unit, the radiological technician can easily and efficiently register the ordering information for image-capturing.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram of a radiographic image capturing system according to an embodiment of the present invention;

FIG. 2 is a perspective view, partly broken away, of a radiation converter serving as an electronic cassette for use in the radiographic image capturing system shown in FIG. 1;

FIG. 3 is a perspective view, partly broken away, of a radiation converter serving as an IP cassette for use in the radiographic image capturing system shown in FIG. 1

FIG. 4 is a block diagram of a portion of the radiographic image capturing system shown in FIG. 1;

FIG. 5 is a flowchart of an operation sequence of the radiographic image capturing system shown in FIG. 1;

FIG. 6 is an illustration of a registration menu displayed on a display unit of a console;

FIG. 7 is an illustration of another registration menu displayed on a display unit of a console;

FIG. 8 is a flowchart of another operation sequence of the radiographic image capturing system shown in FIG. 1; and

FIG. 9 is an illustration of contents displayed on the display unit of the console.

### DESCRIPTION OF THE PREFERRED EMBODIMENTS

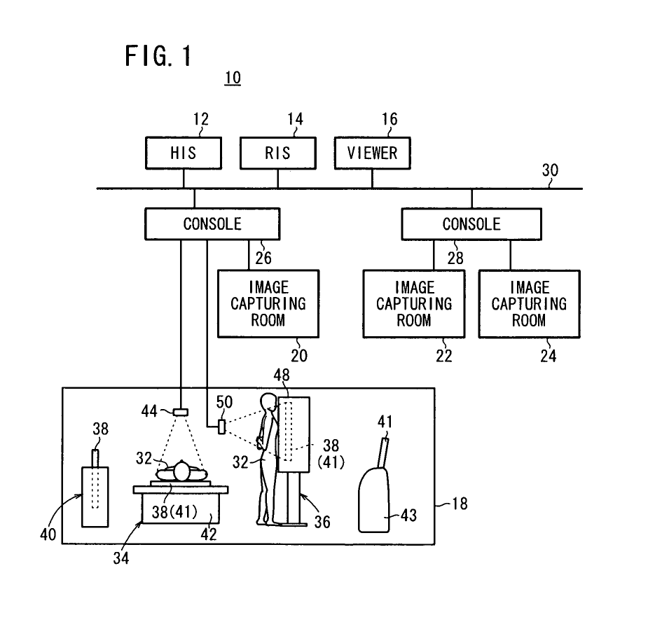

FIG. 1 shows in block form a radiographic image capturing system 10 according to an embodiment of the present invention. As shown in FIG. 1, the radiographic image capturing system 10 comprises a hospital information system (HIS) 12 for managing medical information in a hospital, a radiology information system (RIS) 14 for managing a process of capturing radiographic images in the radiological department of the hospital under the management of the HIS 12, a viewer 16 for allowing a doctor to interpret captured radiographic images for the purpose of diagnosis, and consoles (processors) 26, 28 installed in respective rooms adjacent to a plurality of image capturing rooms 18, 20, 22, 24 in the radiological department. The consoles 26, 28 serve to manage and control various image capturing apparatus having different specifications and image capturing units including radiation converters, stimulable phosphor panels, etc. The HIS 12, the RIS 14, the viewer 16, and the consoles 26, 28 are interconnected by an in-house network 30 in the hospital.

The image capturing room 18 houses therein a first image capturing apparatus (image capturing unit) 34 for capturing radiographic images of a subject 32, typically a patient, while the subject 32 is lying, a second image capturing apparatus (image capturing unit) 36 for capturing radiographic images of a subject 32 while the subject 32 is standing, a cradle 40 for charging a radiation converter 38 for use in the first or second image capturing apparatus 34, 36, and a reading device 43 for reading a radiographic image that has been recorded on a stimulable phosphor panel for use in the first or second image capturing apparatus 34, 36. The other image capturing rooms 20, 22, 24 also house desired image capturing units therein.

The first image capturing apparatus 34 comprises an image capturing base 42 and a radiation generator 44 for applying radiation through the subject 32 to the radiation converter 38 or a cassette 41 housing therein the stimulable phosphor panel which is placed on the image capturing base 42. The second image capturing apparatus 36 comprises an image capturing base 48 into which the radiation converter 38 or the cassette 41 is loaded, and a radiation generator 50 for applying radiation through the subject 32 to the radiation converter 38 or the cassette 41.

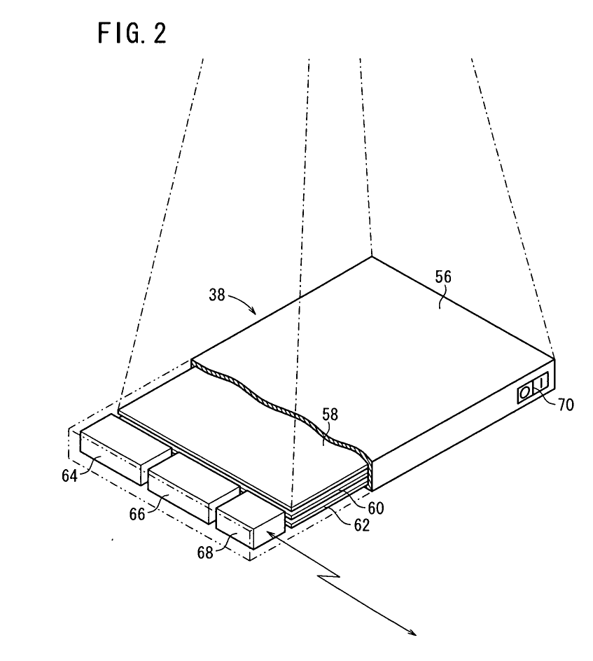

FIG. 2 shows in perspective internal structural details of the radiation converter 38. As shown in FIG. 2, the radiation converter 38, which is also called an electronic cassette, has a casing 56 made of a material permeable to the radiation. The casing 56 houses therein a grid 58 for removing scattered rays of the radiation from the subject 32, a radiation conversion panel 60 for detecting the radiation that has passed through the subject 32 and converting the radiation into electric charge information, and a lead plate 62 for absorbing back scattered rays of the radiation, which are successively arranged in the order named from a surface of the casing 56 which is irradiated with the radiation. The irradiated surface of the casing 56 may be constructed as the grid 58.

The radiation conversion panel 60 may be of a structure including a matrix of thin film transistors (TFTs) and a photoelectric conversion layer which is deposited over the matrix of TFTs and which is made of amorphous selenium (a-Se) or the like for detecting radiation and generating electric charges depending on the detected radiation, so that the radiation conversion panel 60 can generate an image signal representing the electric charges generated by the TFTs.

The casing 56 also houses therein a battery 64 as a power supply of the radiation converter 38, a controller 66 for energizing the radiation converter 38 with electric power supplied from the battery 64, and a transceiver 68 for sending a signal representing a radiographic image of the subject 32 which has been converted by the radiation converter 38 to the console 26 that is connected to the image capturing room 18. The casing 56 has a power supply switch 70 on a side wall thereof for activating the radiation converter 38. The power supply switch 70 also functions as an identification signal generating unit for generating an identification signal for identifying the radiation converter 38 which has been selected by the radiological technician.

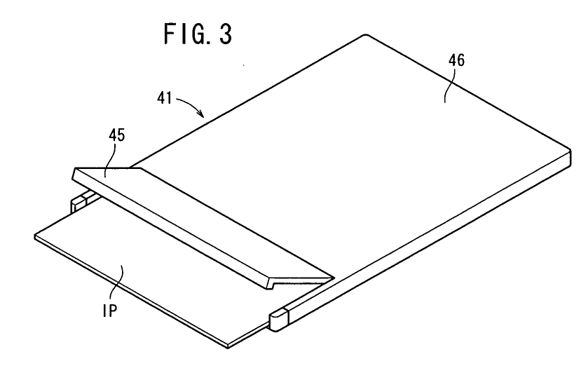

FIG. 3 shows in perspective the cassette 41 serving as the radiation converter. The cassette 41 includes a stimulable phosphor panel IP stored in a casing 46 having a lid 45, and is also called an IP cassette. The stimulable phosphor panel IP has a phosphor layer for storing, as radiation energy, radiation that has passed through the subject 32. Additionally, the stimulable phosphor panel IP is loaded into the reading device 43 to be irradiated with stimulating light, and then emits stimulated light representative of the radiographic image.

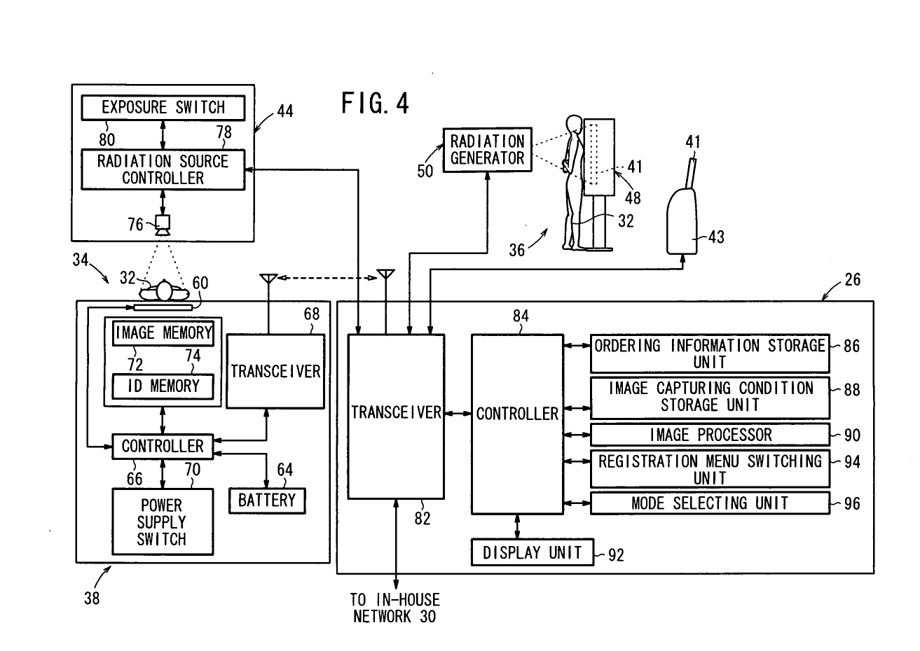

FIG. 4 shows in block form the console 26 and the first and second image capturing apparatus 34, 36 housed in the image capturing room 18 that is managed by the console 26. The console 28 and the image capturing rooms 20, 22, 24 are also similarly constructed. In FIG. 4, the radiation converter 38 is placed in the first image capturing apparatus, and the cassette 41 is loaded in the second image capturing apparatus 36. In such a situation, explanations of the embodiment will be made below.

The radiation converter 38 placed in the first image capturing apparatus 34 includes an image memory 72 for storing a radiographic image converted by the radiation conversion panel 60 as an image signal, and an ID memory 74 for storing ID information which identifies the radiation converter 38. The transceiver 68 of the radiation converter 38 sends the radiographic image stored in the image memory 72 to the console 26 by way of wireless communications. The radiation generator 44 of the first image capturing apparatus 34 comprises a radiation source 76 for emitting radiation, a radiation source controller 78 for controlling the radiation source 76, and an exposure switch 80.

The cassette 41 containing therein the stimulable phosphor panel IP is loaded into the image capturing base 48 of the second image capturing apparatus 36. After the cassette 41 has been removed from the second image capturing apparatus 36, the cassette 41 is loaded into the reading device 43, which then reads a radiographic image recorded on the stimulable phosphor panel IP. The reading device 43 sends a radiographic image read from the stimulable phosphor panel IP to the console 26. The reading device 43 may send the radiographic image to the console 26 by any of wired and wireless communications. The radiation generator 50 is of a structure similar to the radiation generator 44 of the first image capturing apparatus 34.

The console 26 includes a transceiver 82 which sends and receives signals to and from the HIS 12, the RIS 14, the viewer 16, and the other console 28 via the in-house network 30, and which also sends and receives signals to and from the first and second image capturing apparatus 34, 36 in the image capturing room 18. The console 26 is controlled by a controller (detecting unit) 84.

The controller 84 is connected to an ordering information storage unit 86 for storing image capturing ordering information acquired from the RIS 14, an image capturing condition storage unit 88 for storing image capturing conditions for the first and second image capturing apparatus 34, 36 which have been acquired from the RIS 14 or set on the console 26 by the radiological technician, an image processor 90 for processing a radiographic image acquired from the first image capturing apparatus 34 or the second image capturing apparatus 36, a display unit 92 for displaying the processed radiographic image, a registration menu switching unit (selecting unit) 94 for switching registration menus for the ordering information displayed on the display unit 92 depending on the type of image capturing unit to be used, i.e., depending on whether the radiation converter 38 or the cassette 41 is used, and a mode selecting unit (fixing unit) 96 for selecting from a fixed mode for fixing the ordering information without editing and a registration mode for editing the ordering information.

The radiographic image capturing system 10 according to the present embodiment is basically constructed as described above.

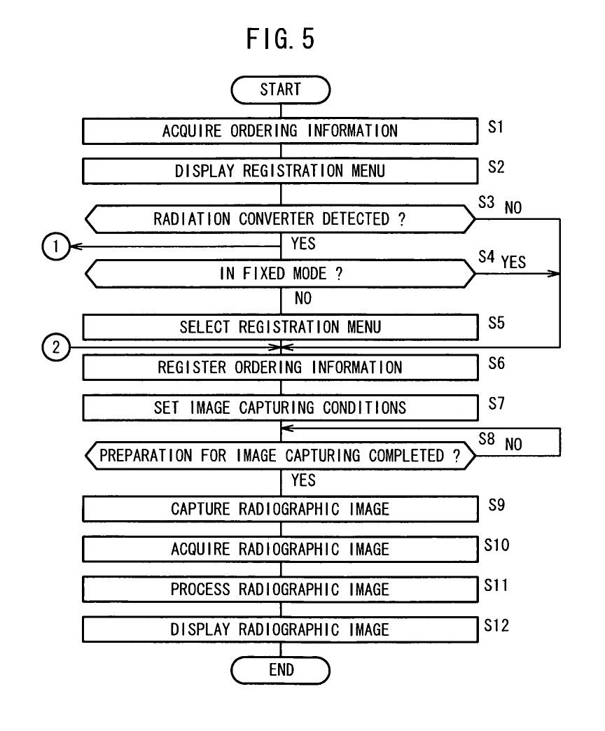

Operation (radiographic image capturing method) of the radiographic image capturing system 10, mainly the console 26 and the image capturing room 18, will be described below with reference to a flowchart shown in FIG. 5.

First, the transceiver 82 of the console 26 acquires ordering information for image-capturing, from the RIS 14 via the in-house network 30 in step S1. The ordering information is generated by the doctor using the RIS 14. The ordering information includes patient information including the name, age, gender, etc. about the patient, i.e., the subject 32, and an image capturing apparatus to be used for capturing a radiographic image of the subject 32, a body region of the subject 32 which is to be imaged, an image capturing method, and image capturing conditions. The image capturing conditions are conditions for determining a dose of radiation to be applied to the subject 32, e.g., a tube voltage and a tube current of the radiation source 76, an irradiation time, etc.

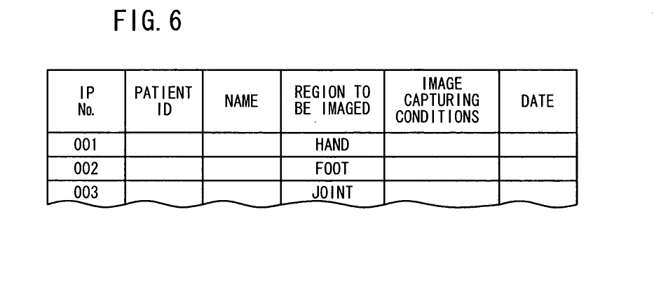

The controller 84 of the console 26 acquires the ordering information, and then displays a registration menu through which necessary ordering information is registered, on the display unit 92 (step S2). FIG. 6 shows an example of the registration menus displayed on the display unit 92. The example shows a registration menu used in the case where the cassette 41 storing therein the stimulable phosphor panel IP is used in the first and second image capturing apparatus 34, 36.

When an image of a patient (i.e., subject) specified according to the ordering information can be normally captured (NO in step S3), the radiological technician registers the ordering information through the displayed registration menu (step S6).

On the other hand, when the subject to be imaged is an infant or a young child and can not keep still during the image-capturing or can not appropriately communicate the region to be imaged, to the radiological technician (YES in step S3), the image capturing apparatus to be used needs to be changed from the cassette 41 housing therein the stimulable phosphor panel IP to the electronic cassette, i.e., the radiation converter 38, in order to cope with such a patient. This is because the radiation converter 38 has a wider range for image-capturing than the stimulable phosphor panel IP, and also because the radiographic image acquired by the radiation converter 38 can be confirmed immediately after the image-capturing, so that recapturing of an image can be performed quickly if necessary.

It is assumed below that the radiological technician brings the radiation converter 38 in the image capturing room 18 in order to deal with the above case where the subject is an infant, a young child, etc.

More specifically, if the radiological technician brings the radiation converter 38 in the image capturing room 18 and turns on the power supply switch 70 of the radiation converter 38, the controller 66 sends ID information for specifying the radiation converter 38, which is stored in the ID memory 74, to the console 26 through the transceiver 68. When the controller 84 of the console 26 receives the ID information, the controller 84 detects that the radiation converter 38 has been brought in the image capturing room 18 for the purpose of image-capturing (YES in step S3). In this case, the radiation converter 38 is guaranteed to be prepared for the capture of a radiographic image of the subject 32, by receipt of the ID information by the controller 84. Consequently, the image capturing unit is free from such a failure that it is not activated and is unable to capturing a radiographic image of the subject 32 when image capturing conditions are sent from the console 26.

Next, the controller 84 determines whether the console 26 is set to the fixed mode for fixing the ordering information without editing or to the registration mode for editing the ordering information (step S4). Either of the above modes may be preliminarily selected by the mode selecting unit 96.

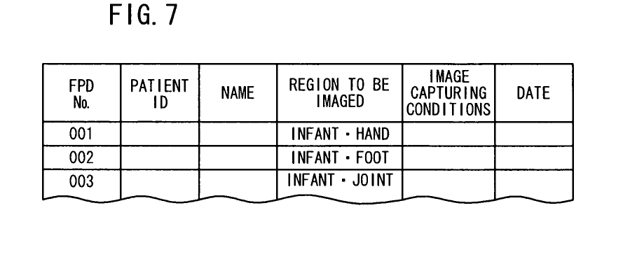

If the console 26 is set to the registration mode (NO in step S4), the registration menu switching unit 94 selects the registration menu for editing the ordering information about the radiation converter 38 (step S5), and displays, on the display unit 92, the registration menu for the radiation converter 38 shown in FIG. 7, instead of the registration menu for the cassette 41 shown in FIG. 6. The radiological technician edits and registers the ordering information necessary for the image-capturing according to the displayed registration menu (step S6). In this case, the radiological technician can edit and register the ordering information easily and efficiently without regard to the type of image capturing unit to be used, i.e., without regard to whether the radiation converter 38 or the cassette 41 is used.

On the other hand, if the console 26 is set to the fixed mode for fixing the ordering information specified by the doctor (YES in step S4), the cassette 41 is used for the image-capturing without change. Then, the radiological technician registers additional ordering information necessary for the image-capturing through the already-displayed registration menu (see FIG. 6) for the cassette 41 (step S6). In this case, a radiographic image desired by the doctor can be acquired without modification of the ordering information specified by the doctor.

As described above, after the necessary ordering information has been registered, the console 26 sends and sets the image capturing conditions into the radiation generator 44 of the first image capturing apparatus 34 or the radiation generator 50 of the second image capturing apparatus 36 which has been selected according to the ordering information (step S7).

After the image capturing conditions has been set in the radiation generator 44 or 50 and preparation for the image-capturing has been completed (YES in step S8), capturing of radiographic images is started (step S9).

Specifically, if the first image capturing apparatus 34 for capturing a radiographic image of the subject 32 while the subject 32 is lying on the image capturing base 42 is selected and the radiological technician brings the radiation converter 38 in the image capturing room 18, then the radiological technician places the radiation converter 38 whose battery 64 has been charged by the cradle 40 on the image capturing base 42, and positions the subject 32 on the radiation converter 38. If the second image capturing apparatus 36 for capturing a radiographic image of the subject 32 while the subject 32 is in an upstanding posture is selected and the radiological technician brings the radiation converter 38 in the image capturing room 18, then the radiological technician loads the radiation converter 38 into the image capturing base 48 and positions the subject 32 on the image capturing base 48.

Then, the radiological technician turns on the exposure switch 80 to apply the radiation emitted from the radiation source 76 to the subject 32. The radiation passes through the subject 32 to the radiation conversion panel 60 of the radiation converter 38 or the stimulable phosphor panel IP housed in the casing 46 of the cassette 41, whereupon a radiographic image of the subject 32 is captured. If the radiation is applied to the radiation conversion panel 60 of the radiation converter 38, the captured radiographic image is temporarily stored in the image memory 72. If the radiation is applied to the stimulable phosphor panel IP of the cassette 41, the cassette 41 housing therein the stimulable phosphor panel IP on which a radiographic image has been recorded is loaded into the reading device 43 to read the radiographic image.

The console 26 acquires the radiographic image from the first image capturing apparatus 34 or the second image capturing apparatus 36 in step S10. Then, the image processor 90 processes the radiographic image in step S11, and the processed radiographic image is displayed on the display unit 92 in step S12. The radiological technician confirms the radiographic image displayed on the display unit 92 and determines whether the radiographic image is acceptable or not, i.e., whether it needs to be recaptured or not. If the radiographic image is not acceptable, i.e., it needs to be recaptured, then another radiographic image of the subject 32 is captured. In this case, when the radiographic image of the subject 32 is captured using the radiation converter 38, the radiographic image can be acquired immediately, and thus the radiological technician can determine quickly whether the radiographic image needs to be recaptured or not. If the radiographic image is acceptable, then it is sent via the in-house network 30 to the viewer 16 and displayed thereon so as to be interpreted by the doctor for diagnosis.

The present invention is not limited to the various embodiments described above, but various changes and modifications may be made to the embodiments within the scope of the invention.

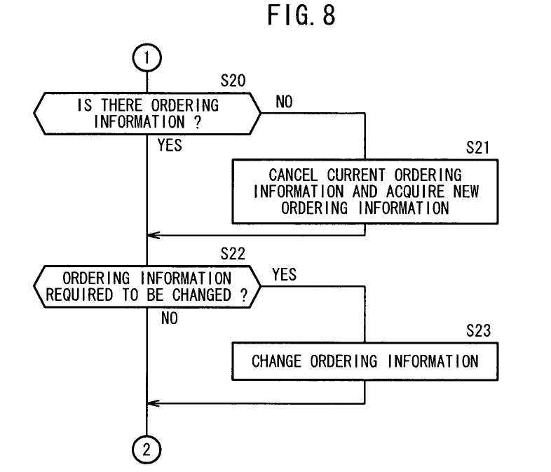

FIG. 8 is a flowchart of another operation sequence of the radiographic image capturing system 10.

It is assumed that when the radiological technician is going to capture a radiographic image of the subject 32 using an image capturing apparatus placed in the image capturing room 20, the image capturing room 20 has been occupied, and the radiological technician has decided to change from the image capturing room 20 to the image capturing room 18. In this case, even if the radiological technician prepares for the image-capturing in the image capturing room 18, the ordering information storage unit 86 of the console 26 connected to the image capturing room 18 does not store the ordering information for the image capturing room 18 (NO in step S20) although the ordering information storage unit 86 stores the ordering information for the image capturing room 20.

The console 26 requests and acquires new ordering information for the subject 32 (ordering information for the image capturing room 18) from the RIS 14, and cancels the ordering information for the image capturing room 20 in step S21. In this case, since the new ordering information is acquired depending on the image-capturing of the subject 32, the ordering information does not need to be changed (NO in step S22) and the new ordering information is registered as it is (step S6). Thereafter, a radiographic image of the subject 32 is captured in the image capturing room 18 according to the new ordering information.

It is also assumed that when the radiological technician is going to capture a radiographic image of the subject 32 using the second image capturing apparatus 36 in the image capturing room 18 according to the ordering information, the subject 32 cannot take an upstanding posture due to a handicapped leg or the like. In this case, the radiological technician decides to change from the second image capturing apparatus 36 to the first image capturing apparatus 34 for capturing a radiographic image of the subject 32 while the subject 32 is lying on the image capturing base 42.

Then, when the radiological technician prepares the first image capturing apparatus 34 for the capture of a radiographic image of the subject 32 and turns on the power supply switch 70 of the radiation converter 38 to be used, the controller 66 sends ID information which is stored in the ID memory 74, to the console 26. When the controller 84 of the console 26 receives the ID information (YES in step S3), the controller 84 confirms whether there is ordering information or not (step S20). If there is ordering information (YES in step S20), the controller 84 confirms whether the ID information corresponds to the image capturing apparatus specified by the ordering information or not (step S22).

Since the ID information and the image capturing apparatus specified by the ordering information do not correspond to each other in this case (YES in step S22), the controller 84 changes the contents of the ordering information (step S23), registers the changed ordering information (step S6), selects image capturing conditions with respect to the changed image capturing apparatus from the image capturing condition storage unit 88, and sets the selected image capturing conditions in the radiation generator 44 of the first image capturing apparatus 34.

Thus, the radiological technician does not need to take the trouble of returning to the console 26, changing image capturing conditions and registering ordering information. It is assumed in this respect that though the radiological technician is unable to change the contents themselves of the ordering information produced by the doctor, actual image capturing information, which is part of the ordering information, indicating which image capturing unit has been used and how the radiographic image has been captured, can be set as a change of the ordering information made by the radiological technician, and can be recorded.

When the first image capturing apparatus 34 is used to capture a radiographic image of the subject 32, the radiological technician may bring a radiation converter 38 that can be used, from another image capturing room into the image capturing room 18, and prepare the radiation converter 38 for the capture of a radiographic image of the subject 32. At this time, if the radiological technician turns on the power supply switch 70 of the radiation converter 38, the radiation converter 38 sends the ID information to the console 26, thereby allowing the radiation converter 38 to capture a radiographic image.

As an image capturing apparatus selected by the radiological technician and a console which supplies appropriate image capturing conditions to the image capturing apparatus and processes an acquired radiographic image are properly associated with each other, as described above, the subject 32 as a patient is prevented from being mistaken and the image capturing conditions are prevented from being set in error, so that a desired radiographic image of the subject 32 can reliably be acquired.

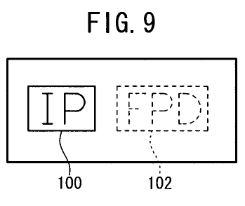

As shown in FIG. 9, on the display screen of the display unit 92, there are displayed a display button (“IP” icon) 100 for selecting the registration of the ordering information about the second image capturing apparatus 36 and a display button (“FPD” icon) 102 for selecting the registration of the ordering information about the first image capturing apparatus 34. In FIG. 9, the display button 102 is placed in a blackout state, which indicates that the display button 102 can not be selected.

If the display button 100 is selected through the operation of a mouse or a keyboard (not shown), the registration menu shown in FIG. 6 is displayed on the screen. On the other hand, when the display button 102 is not placed in the blackout state, i.e., when the display button 102 can be selected, if the display button 102 is selected through the operation of the mouse or the keyboard, the registration menu shown in FIG. 7 is displayed on the screen.

If the display button 102 placed in the blackout state is held down for a longer period of time through the operation of the mouse or the keyboard, the display button 102 is switched from the blackout state to a selectable state, and then the registration menu shown in FIG. 7 is displayed on the screen. In this case, the display button 100 is switched from the selectable state to the blackout state.

The above-mentioned switchable display buttons 100, 102 facilitate editing and registering of the registration menus.

Although certain preferred embodiments of the present invention have been shown and described in detail, it should be understood that various changes and modifications may be made therein without departing from the scope of the appended claims.

What is claimed is:

1. A radiographic image capturing system comprising:
image capturing units for capturing a radiographic image of a subject; and
a processor for supplying image capturing conditions to the image capturing units and processing the radiographic image captured by the image capturing units,
wherein the processor comprises:
a display unit for displaying a registration menu through which ordering information for image-capturing is registered, the ordering information including one of the image capturing units to be used and the image capturing conditions;
a detecting unit for detecting a type of the one of the image capturing units to be used; and
a selecting unit for selecting the registration menu to be displayed on the display unit, depending on the detected type of the one of the image capturing units to be used.

2. A radiographic image capturing system according to claim 1, wherein at least one of the image capturing units comprises:
a radiation source for outputting radiation; and
a radiation converter for converting the radiation which has passed through the subject into a radiographic image represented by an electric signal;
wherein the radiation source is controlled according to the image capturing conditions depending on characteristics of the radiation converter.

3. A radiographic image capturing system according to claim 2, wherein the radiation converter sends signals to and receives signals from the processor by way of wireless communications.

4. A radiographic image capturing system according to claim 1, wherein at least one of the image capturing units comprises:
a radiation source for outputting radiation; and
a stimulable phosphor panel for storing the radiation which has passed through the subject as a radiation energy;
wherein the radiation source is controlled according to the image capturing conditions depending on characteristics of the stimulable phosphor panel.

5. A radiographic image capturing system according to claim 1, further comprising a fixing unit for inhibiting selection of the registration menu by the selecting unit and fixing the registration menu.

6. A processor for supplying image capturing conditions to image capturing units for capturing a radiographic image of a subject and processing the radiographic image that has been captured by the image capturing units according to the image capturing conditions, the processor comprising:
a display unit for displaying a registration menu through which ordering information for image-capturing is registered, the ordering information including one of the image capturing units to be used and the image capturing conditions;
a detecting unit for detecting a type of the one of the image capturing units to be used; and
a selecting unit for selecting the registration menu to be displayed on the display unit, depending on the detected type of the one of the image capturing units to be used.

7. A radiographic image capturing method comprising the steps of:
displaying, on a display unit, a registration menu through which ordering information for image-capturing is registered, the ordering information including an image capturing unit to be used and image capturing conditions;
detecting a type of the image capturing unit to be used, with a detecting unit;
selecting the registration menu to be displayed on the display unit with a selecting unit, depending on the detected type of the image capturing unit to be used;
supplying the image capturing conditions to the image capturing unit according to the selected registration menu;
capturing a radiographic image with the image capturing unit based on the image capturing conditions; and
processing the captured radiographic image with a processor.
